(19) United States
(12) Patent Application Publication
(10) Pub. No.: US 2015/0266762 A1
(43) Pub. Date: Sep. 24, 2015

(54) COMPLEX APPARATUS OF REVERSE ELECTRODIALYSIS EQUIPMENT AND DESALINATION PLANT AND METHOD FOR IMPROVING POWER DENSITY THEREOF

(71) Applicant: KOREA INSTITUTE OF SCIENCE AND TECHNOLOGY, Seoul (KR)

(72) Inventors: Jong Hyun JANG, Seoul (KR); Hyoung-Juhn KIM, Suwon-si (KR); Suk Woo NAM, Seoul (KR); Jaeyune RYU, Seoul (KR); Sung Jong YOO, Seoul (KR); Sung Pil YOON, Seongnam-si (KR); Tae Hoon LIM, Seoul (KR); Eun Ae CHO, Seoul (KR); Insoo CHOI, Seoul (KR); Jonghee HAN, Seoul (KR); Jun Young HAN, Seoul (KR); Dirk HENKENSMEIER, Seoul (KR)

(73) Assignee: KOREA INSTITUTE OF SCIENCE AND TECHNOLOGY, Seoul (KR)

(21) Appl. No.: 14/339,884

(22) Filed: Jul. 24, 2014

(30) Foreign Application Priority Data
Mar. 21, 2014 (KR) 10-2014-0033499

(51) Int. Cl. C02F 9/00; C02F 1/14; C02F 1/469

(52) U.S. Cl. CPC C02F 9/00; C02F 1/4693; C02F 1/14; C02F 2103/08

(57) ABSTRACT

In a complex system including a desalination plant and a reverse electrodialysis equipment, a concentrated sea water discharged from the desalination plant having a salt concentration of about 50 to 75 g/L or about 50 to 60 g/L is provided as a high-concentration salt solution of the reverse electrodialysis equipment while low salinity water having a salt concentration of about 0.01 to 2 g/L, most preferably about 0.01 to 1 g/L, is provided as a low-concentration salt solution of the reverse electrodialysis equipment. Thereby, a recycling degree of a concentrated sea water may be enhanced as well as a power density produced by the complex system is significantly improved.

### CROSS-REFERENCE TO RELATED APPLICATION

This application claims priority to Korean Patent Application No. 10-2014-0033499, filed on Mar. 21, 2014, and all the benefits accruing therefrom under 35 U.S.C. §119, the contents of which in its entirety are herein incorporated by reference.

### BACKGROUND

1. Field

The present disclosure relates to a complex apparatus of reverse electrodialysis equipment and desalination plant and a method for improving a power density thereof.

2. Description of the Related Art

Power may be produced using a reverse electrodialysis (hereinafter, also referred to as RED).

That is, in the reverse electrodialysis, electric energy may be produced by using selective ion penetration due to a concentration difference through a membrane (or, ion exchange membrane) between two ion solutions having different ion concentrations, as well known in the art.

For example, reverse electrodialysis equipment may include a membrane stack having cation exchange membranes and anion exchange membranes stacked alternately, and electrodes respectively provided at an end of each stack. A high-concentration salt solution and a low-concentration salt solution are supplied into the reverse electrodialysis equipment, and a solute passes in a dissociated state from the high-concentration salt solution through the ion exchange membrane, an electric current may flow and voltages may be generated at both ends of the stack electrodes. This reverse electrodialysis-type power plant may produce energy with low costs.

Meanwhile, there has been proposed a technique in which the reverse electrodialysis equipment is connected to a desalination plant (or, a desalination unit; hereinafter, also referred to as DSU) to configure a complex system, so that the desalination plant (DSU) purifies (desalinize) a sea water into a fresh water and the concentrated sea water from the desalination plant is provided as a high-concentration salt solution to the reverse electrodialysis equipment (US 2008/0230376 A1).

FIG. 1 is a schematic diagram showing an example of a conventional complex system of desalination plant and reverse electrodialysis equipment.

Referring to FIG. 1, in the conventional complex system of a desalination plant and a reverse electrodialysis equipment, a sea water is supplied respectively to the desalination plant (DSU) and the reverse electrodialysis equipment (RED). The desalination plant (DSU) receiving the sea water converts the sea water into a purified fresh water, and provides a concentrated sea water (brine, about 70 to 80 g/L) having an increased salinity to the reverse electrodialysis equipment (RED). In the reverse electrodialysis equipment (RED), the concentrated sea water (about 70 to 80 g/L) is used as a high-concentration salt solution and the sea water (about 35 to 40 g/L) is used as a low-salinity salt solution to produce a power, and the sea water diluted or concentrated while passing through the reverse electrodialysis equipment is discharged out to sea. The power produced by the reverse electrodialysis equipment may be provided to the desalination plant.

### SUMMARY

According to an observation by the inventors of the present disclosure, the conventional complex system of desalination plant and reverse electrodialysis equipment uses a sea water directly as a low-concentration salt solution, but due to a high concentration of the sea water (about 35 to 40 g/L), a power density produced by the electrodialysis equipment is very low, which in turn results in a low power generation efficiency. In addition, considering that the conventional complex system of desalination plant and reverse electrodialysis equipment should be constructed in a large scale, such low power generation efficiency may be very disadvantageous in economical point of view, and may lead to an unbalanced design of the complex system.

Moreover, the conventional technique is just focusing on a concentration difference between a high salinity water and a low salinity water but does not recognize other important factors such as a concentration ratio, resistance, OCV, power density change, etc. of the high salinity water and the low salinity water.

According to embodiments of the present disclosure, a method for enhancing a recycling of a high-concentration sea water in a complex system of desalination plant and reverse electrodialysis equipment and also greatly improving a power density produced by the reverse electrodialysis equipment in spite of a resistance increase of the reverse electrodialysis equipment is provided. Further, a complex system (apparatus) of desalination plant and reverse electrodialysis equipment with a greatly improved power density is provided.

In one aspect of the embodiments, provided is a complex apparatus comprising:

a desalination plant, wherein the desalination plant receives a sea water, desalinize at least a part of the sea water into a fresh water, and discharges a concentrated sea water whose concentration is increased after the desalinization;

a reverse electrodialysis equipment, wherein the concentrated sea water discharged from the desalination plant is provided to the reverse electrodialysis equipment as a high-concentration salt solution;

a low salinity water supplying unit for providing a low salinity water to the reverse electrodialysis equipment as a low-concentration salt solution,

wherein the concentrated sea water has a salt concentration of about 50 to 75 g/L or about 50 to 60 g/L, and the low salinity water has a salt concentration of about 0.01 to 20 g/L, preferably about 0.01 to 10 g/L or about 0.01 to 5 g/L, particularly preferably about 0.01 to 2 g/L, most preferably about 0.01 to 1 g/L., and

the reverse electrodialysis equipment produces a power by means of the reverse electrodialysis which uses the low salinity water as a low-concentration salt solution and uses the concentrated sea water as a high-concentration salt solution.

In another aspect of the embodiments, provided is a method for improving a power density produced by a reverse electrodialysis of a complex apparatus of desalination plant and reverse electrodialysis equipment, comprising:

supplying a sea water to the desalination plant and at least partially converting (desalinizing) the sea water into a fresh water,

supplying a concentrated sea water, whose salt concentration is increased to about 50 to 75 g/L or 50 to 60 g/L after the desalination, to the reverse electrodialysis equipment,

supplying a low salinity water having a salt concentration of about 0.01 to 20 g/L, preferably about 0.01 to 10 g/L or about 0.01 to 5 g/L, particularly preferably about 0.01 to 2 g/L, most preferably about 0.01 to 1 g/L, to the reverse electrodialysis equipment, and

wherein the reverse electrodialysis equipment produces a power by means of the reverse electrodialysis using the low salinity water and the concentrated sea water.

In an example embodiment, the low salinity water may employ a fresh water such as river water, stored rainwater (this means that rainwater may be stored and reused), discharge water after sewage disposal, discharge water from power plants, discharge water from steelworks or the like, and the fresh water may have said salt concentration of the low salinity water.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a schematic diagram showing a conventional complex system of desalination plant and reverse electrodialysis equipment.

FIG. 2 is a schematic diagram showing a complex system of desalination plant and reverse electrodialysis equipment according to an embodiment of the present disclosure.

FIG. 3 is a conceptual diagram for illustrating an ion exchange flow of the reverse electrodialysis equipment employed in the complex system of FIG. 2.

FIG. 4 is a schematic diagram showing a unit cell of the reverse electrodialysis equipment of the complex apparatus according to an embodiment of the present disclosure.

FIG. 5 is a graph for evaluating power performance of Example, Comparative Example 1 and Comparative Example 2, in which an X axis represents a concentration ratio (Cₛ/Cᵣ) of a high-concentration salt solution to a low-concentration salt solution and a Y axis represents an open circuit voltage (OCV).

FIG. 6 shows an I-V curve (FIG. 6a) representing output currents and voltages, and an I-P curve (FIG. 6b) representing output currents and powers with respect to Example, Comparative Example 1 and Comparative Example 2. In FIG. 6a, an X axis represents a current density (unit: mA/cm²) and a Y axis represents a voltage (unit: V). In FIG. 6b, an X axis represents a current density (unit: mA/cm²) and a Y axis represents a power density (unit: mW/cm²).

FIG. 7a is a graph showing an OCV according to a concentration of low salinity water in Experiment 2. In FIG. 7a, an X axis represents a concentration of low salinity water (unit: g/L) and a Y axis represents an OCV (unit: V).

FIG. 7b is a graph showing a relative power density (Rel. Pmax) according to a concentration of low salinity water in Experiment 2. In FIG. 7b, an X axis represents a concentration of low salinity water (unit: g/L) and a Y axis represents a relative power density (Rel. Pmax) (unit: none).

FIG. 8a is a graph showing an OCV according to a concentration of low salinity water in Experiment 3. In FIG. 8a, an X axis represents a concentration of low salinity water (unit: g/L) and a Y axis represents an OCV (unit: V).

FIG. 8b is a graph showing a relative power density (Rel. Pmax) according to a concentration of low salinity water in Experiment 3. In FIG. 8b, an X axis represents a concentration of low salinity water (unit: g/L) and a Y axis represents a relative power density (Rel. Pmax) (unit: none).

FIG. 9a is a graph showing an OCV according to a concentration of low salinity water in Experiment 4. In FIG. 9a, an X axis represents a concentration of low salinity water (unit: g/L) and a Y axis represents an OCV (unit: V).

FIG. 9b is a graph showing a relative power density (Rel. Pmax) according to a concentration of low salinity water in Experiment 4. In FIG. 9b, an X axis represents a concentration of low salinity water (unit: g/L) and a Y axis represents a relative power density (Rel. Pmax) (unit: none).

FIG. 10 is a graph showing a relative power density (Rel. Pmax) according to a concentration of low salinity water in Experiment 5 (that is, a graph showing Rel. Pmax according to a concentration of low salinity water, wherein Rel. Pmax is calculated according to a resistance change in Experiment 3). In FIG. 10, an X axis represents a concentration of low salinity water (unit: g/L) and a Y axis represents a relative power density (Rel. Pmax) (unit: none).

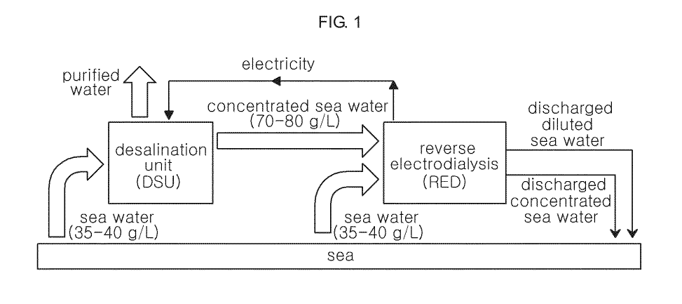

### DETAILED DESCRIPTION

Example embodiments are described more fully hereinafter. The invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. In the description, details of features and techniques may be omitted to more clearly disclose exemplary embodiments.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Furthermore, the use of the terms a, an, etc. do not denote a limitation of quantity, but rather denote the presence of at least one of the referenced item. The terms “first,” “second,” and the like do not imply any particular order, but are included to identify individual elements. Moreover, the use of the terms first, second, etc. do not denote any order or importance, but rather the terms first, second, etc. are used to distinguished one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments will be described in detail with reference to the accompanying drawings.

In this context, high-concentration salt solution means a solution whose salt concentration is relatively high in comparison to a low-concentration salt solution provided to a reverse electrodialysis equipment.

In this context, low-concentration salt solution means a solution whose salt concentration is relatively low in comparison to the high-concentration salt solution provided to a reverse electrodialysis equipment.

In this context, discharge water after sewage disposal means a treated water discharged after sewage disposal is performed so that the treated water is suitable for discharge or reuse.

In this context, a concentrated sea water refers that a concentration of sea water becomes higher than that of sea water.

The inventors of the present disclosure have found that in a complex system of desalination plant and reverse electrodialysis equipment, it is possible to greatly increase a power produced by the reverse electrodialysis equipment by using a high salinity water having a salt concentration of about 50 to 75 g/L or about 50 to 60 g/L, which is a concentrated sea water discharged from the desalination plant, as a high-concentration salt solution provided to the reverse electrodialysis equipment and also by using a low salinity water having a low salt concentration, preferably of about 0.01 to 2 g/L, most preferably of about 0.01 to 1 g/L as a low-concentration salt solution provided to the reverse electrodialysis equipment instead of a sea water.

That is, in embodiments of the present disclosure, a sea water is supplied to the desalination plant and desalinized, and a concentrated sea water after desalinization is provided to the reverse electrodialysis equipment as a high-concentration salt solution while a low salinity water having the said concentration range is provided to the reverse electrodialysis equipment, so as to improve a power density of the complex apparatus including a desalination plant and a reverse electrodialysis equipment. Herein, the reverse electrodialysis equipment produces power by means of reverse electrodialysis which uses the low salinity water as a low-concentration salt solution and uses the concentrated sea water as a high-concentration ion solution.

The concentrated sea water may have a salt concentration of about 50 to 75 g/L, or preferably about 50 to 60 g/L.

The low salinity water may have a salt concentration of about 0.01 to 20 g/L, preferably about 0.01 to 10 g/L or about 0.01 to 5 g/L.

Especially, the salt concentration of low salinity water is more preferably about 0.01 to 2 g/L, most preferably about 0.01 to 1 g/L in the sense that the power density and the OCV may be significantly increased despite the increase of resistance as described below.

Here, the power density (Pmax: that is, the maximum power density) and OCV (open circuit voltage) of the complex apparatus including a desalination plant and a reverse electrodialysis equipment theoretically satisfy the following relation with regard to a concentration (Cs) of a concentrated sea water and a concentration (Cr) of a low salinity water.

$$\frac{\frac{{E}_{OCV} = {α}_{CEM} \frac{RT}{F} ln ( {γ}_{S}^{Na} {C}_{s} )}{{γ}_{R}^{Na} {C}_{R}} + {α}_{AEM} \frac{RT}{F} ln ( {γ}_{S}^{Cl} {C}_{s} )}{{γ}_{R}^{Cl} {c}_{R}} \qquad [ Equation 1 ]$$

[E_{OCV}: open circuit voltage, C_{S}: concentration of concentrated sea water, C_{R}: concentration of low salinity water, γ_{S}^{Na}, γ_{S}^{Cl}: respectively Na⁺ activity coefficient, or activity coefficient of concentrated sea water, α_{AEM}: respectively Na⁺ activity coefficient, or activity coefficient of low salinity water, α_{CEM}: transfer coefficient of cation exchange membrane, α_{AEM}: transfer coefficient of anion exchange membrane, R: gas constant, T: temperature, F: Faraday constant]

$${P}_{max} = \frac{{E}_{OCV}^{2}}{4 R} \qquad [ Equation 2 ]$$

[E_{OCV}: open circuit voltage, Pₘₐₓ: power density, R: resistance (constant)]

As seen from Equations 1 and 2, it may be understood that not an absolute difference in salt concentrations between the concentrated sea water and the low salinity water, but a ratio of salt concentrations of the concentrated sea water and the low salinity water has a relation with the OCV and the power density (Pmax). In addition, the change of the ratio of salt concentrations of the concentrated sea water and the low salinity water may also have a linear relation with the change of resistance.

When the concentrated sea water has a salt concentration of about 50 to 75 g/L, preferably about 50 to 60 g/L, both the OCV and the power density shows significant increase if the low salinity water has a salt concentration of about 2 g/L or less, or lower than about 2 g/L, particularly about 1 g/L or less, or lower than about 1 g/L.

Meanwhile, if the low salinity water has a salt concentration lower than about 0.01 g/L, a resistance (R in Equation 2) may significantly increase during reverse electrodialysis. To this end, the low salinity water has a concentration of about 0.01 g/L or more.

Therefore, according to the example embodiments, in the aspect that the power density and the OCV significantly increases in spite of the increase of resistance, the low salinity water has a concentration of particularly preferably about 0.01 to 2 g/L, most preferably about 0.01 to 1 g/L.

In this regard, if the concentration of the low salinity water is lowered while the high salinity water has a constant concentration, the resistance in the reverse electrodialysis equipment increases. However, since Pmax is proportional to the square of the OCV as shown in Equation 2, the increase of the Pmax according to the increase of OCV is much greater in comparison to the decrease of the Pmax according to the increase of resistance. Therefore, even though the increase of resistance according to the change of concentration of the low salinity water is taken into consideration, the change tendency of OVC according to the concentration change of the low salinity water may determine the change tendency of Pmax (however, if the concentration of low salinity water is smaller than about 0.01 g/L, the resistance may significantly increase, and thus the lower limit of the concentration of low salinity water is limited to be about 0.01 g/L or more).

If the high salinity water has a concentration of about 50 to 75 g/L, or preferably about 50 to 60 g/L, and when the low salinity water has a concentration of particularly preferably about 0.01 to 2 g/L, most preferably about 0.01 to 1 g/L, the Pmax may significantly increase in spite of the increase of resistance according to the decrease of concentration of the low salinity water (see Experimental Examples 2 to 4, and see also Experimental Example 5).

According to example embodiments, the low salinity water may employ river water directly drawn from a river, stored rainwater, discharge water after sewage disposal obtained by treating domestic sewage or industrial sewage, discharge water from power plants, discharge water from steelworks or the like.

If river water, in particular, stored rainwater, discharge water after sewage disposal, discharge water from power plants, discharge water from steelworks or the like, is used as the low salinity water, it may be economically useful.

In addition, when not a sea water but a fresh water such as river water, stored rainwater, discharge water after sewage disposal, discharge water from power plants, discharge water from steelworks or the like is used as the low-concentration salt solution, construction of a plant or selection of a construction position may be facilitated since there is no need to directly draw water from sea.

In the example embodiments, the concentration of the low salinity water may be measured and adjusted so that the river water, stored rainwater, discharge water after sewage disposal, discharge water from power plants, discharge water from steelworks or the like has the concentration of the low salinity water (with a salt concentration of particularly preferably about 0.01 to 2 g/L, most preferably about 0.01 to 1 g/L), and then the low salinity water may be provided to the reverse electrodialysis equipment.

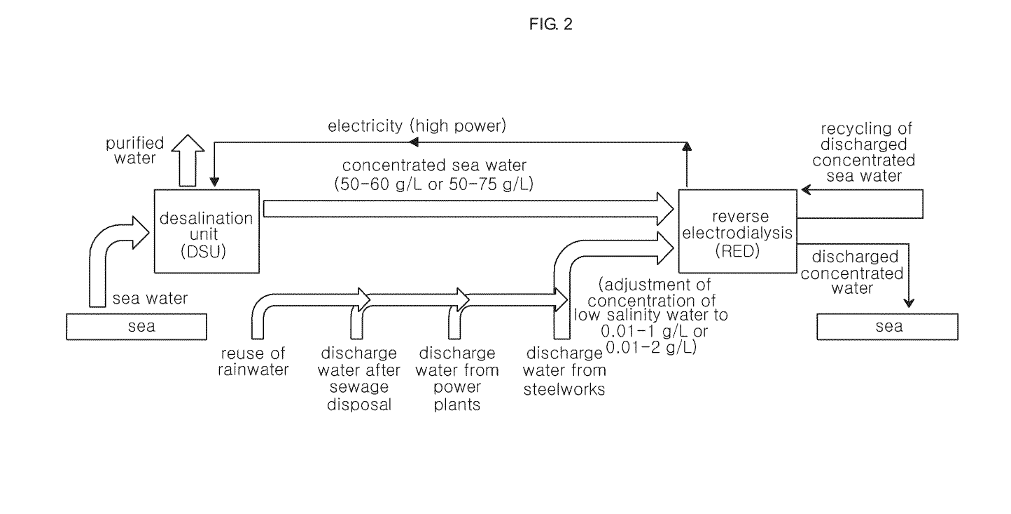

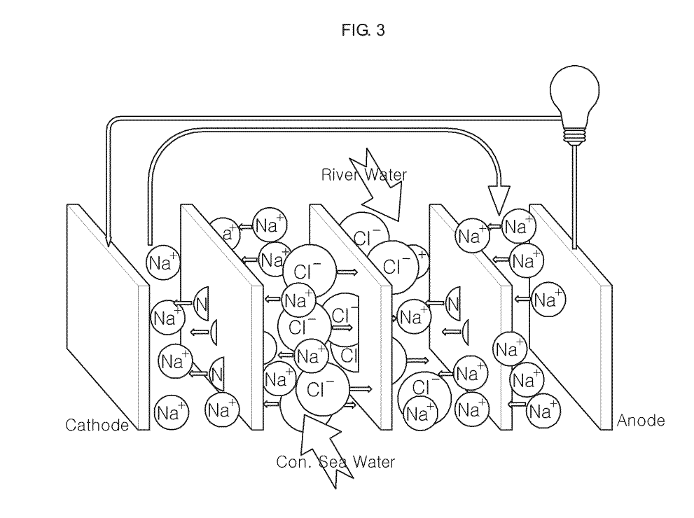

FIG. 2 is a schematic diagram showing a complex system of a desalination plant and a reverse electrodialysis equipment according to an example embodiment of the present disclosure.

Referring to FIG. 2, in the complex system of a desalination plant and a reverse electrodialysis equipment, sea water (having a salt concentration of about 30 g/L) is supplied to a desalination plant (DSU).

The desalination plant (DSU) receives sea water, desalinize at least a part of the received sea water into fresh water and discharges purified fresh water, and provides concentrated sea water (about 50 to 75 g/L) having an enhanced salinity accordingly is provided to the reverse electrodialysis equipment (RED).

Meanwhile, the reverse electrodialysis equipment (RED) produces power by using the concentrated sea water (about 50 to 75 g/L) as a high-concentration salt solution and using low salinity water (with a salt concentration of particularly preferably about 0.01 to 2 g/L, most preferably about 0.01 to 1 g/L) as a low-concentration salt solution.

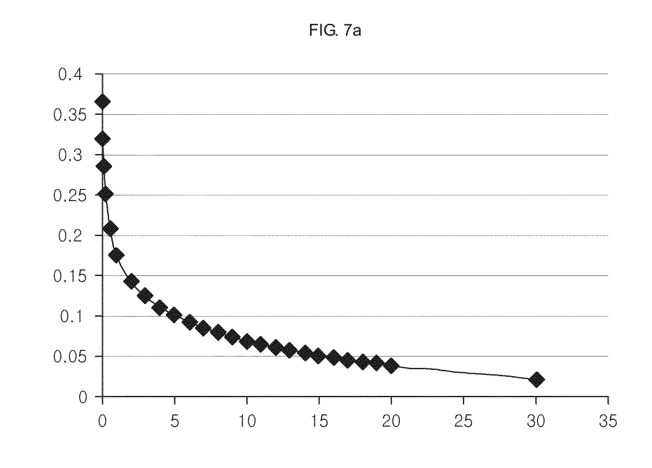

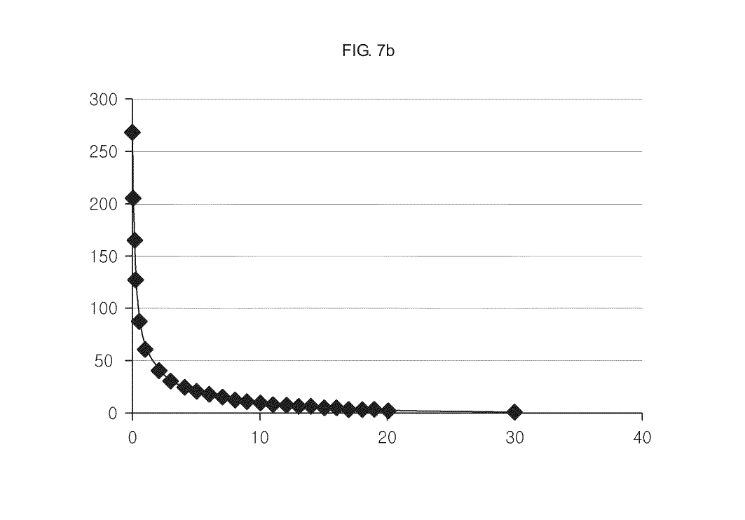

Since the low salinity water having a low salt concentration (particularly preferably about 0.01 to 2 g/L, most preferably about 0.01 to 1 g/L) is used as a low-concentration salt solution provided to the reverse electrodialysis equipment (RED) instead of sea water, the output power of the reverse electrodialysis equipment may be significantly improved (see Tables 3 to 6 and FIGS. 7 to 10; it may be understood that the power density rapidly increases when the salt concentration is about 2 g/L or less, particularly about 1 g/L or less) and high power may be produced. In these example embodiments, the produced high power may be provided to the desalination plant (DSU) to enhance the efficiency of the desalination plant.

The low salinity water (with a salt concentration of particularly preferably about 0.01 to 2 g/L, most preferably about 0.01 to 1 g/L) and the concentrated sea water (with a salt concentration of about 50 to 75 g/L or about 50 to 60 g/L) provided to the reverse electrodialysis equipment (RED) may be discharged to the sea with an increased or decreased concentration after passing through the reverse electrodialysis equipment.

Meanwhile, according to these example embodiments, when high-salinity concentrated sea water having a salt concentration in the above range (about 50 to 75 g/L or about 50 to 60 g/L) is used, and low salinity water having a very low salt concentration (particularly preferably about 0.01 to 2 g/L, most preferably about 0.01 to 1 g/L) is used, a concentration reduction ratio (or degree) of the high-salinity concentrated sea water while passing through the reverse electrodialysis equipment (namely, a concentration reduction ratio of the high-salinity concentrated sea water before and after passing through the reverse electrodialysis equipment) is very small. For example, in Experiment 1, the high salinity water has a concentration reduction ratio of about 1/100000 or less.

Therefore, in example embodiments of the present disclosure, since the high-salinity concentration of the concentrated sea water passing through the reverse electrodialysis equipment may be maintained substantially constantly (for example, with a concentration reduction ratio of about 1/1000 or less), the high-salinity concentrated sea water passing through the reverse electrodialysis equipment may be supplied again to the reverse electrodialysis equipment for recycling without discharging to the sea and the power efficiency of the entire complex apparatus may be enhanced.

In an example embodiment, the desalination plant (DSU) may desalinize sea water into fresh water by using a known method, for example using solar rays. In addition, in an example embodiment, the desalination plant may use the power produced by the reverse electrodialysis equipment.

The reverse electrodialysis equipment (RED) may use known reverse electrodialysis equipment, but in example embodiments of the present disclosure, the reverse electrodialysis equipment may in particular include a fresh water providing unit for providing fresh water such as river water, stored rainwater, discharge water after sewage disposal, discharge water from power plants, discharge water from steelworks or the like to the reverse electrodialysis equipment. Moreover, the fresh water providing unit may further include a concentration measuring and adjusting unit for measuring and adjusting a salt concentration of the fresh water.

For reference, FIG. 3 is a conceptual diagram for illustrating an ion exchange flow of the reverse electrodialysis equipment employed in the complex system of FIG. 2. FIG. 3 shows that high-concentration concentrated sea water (concentrated sea water) and fresh water (river water) flow and a current is generated by means of reverse electrodialysis through an ion exchange membrane. Herein, discharge water after sewage disposal, discharge water from power plants and discharge water from steelworks used as the fresh water are respectively in a treated state to a level satisfying discharge conditions.

According to embodiments of the present disclosure, it is possible to enhance recycling of a high-concentration concentrated sea water in a complex system of desalination plant and reverse electrodialysis equipment and also greatly improve a power density produced by the reverse electrodialysis equipment in spite of the resistance increase of the reverse electrodialysis equipment.

Hereinafter, the present disclosure will be described in more detail based on Examples and Experiments, but the present disclosure is not limited thereto.

### Experiment 1

### Example and Comparative Example

In this experiment, for the complex system of a desalination plant and a reverse electrodialysis equipment according to an embodiment of the present disclosure [Example: this will be called DSU-RED (concentrated sea water/fresh water)], the change of a power density was observed in comparison to a comparative system [Comparative Example 1: this will also be called a DSU-RED (concentrated sea water/sea water)] and a reverse electrodialysis equipment not using a desalination plant [Comparative Example 2: this will also be called a RED (sea water/fresh water)].

Reverse electrodialysis equipment was firstly configured.

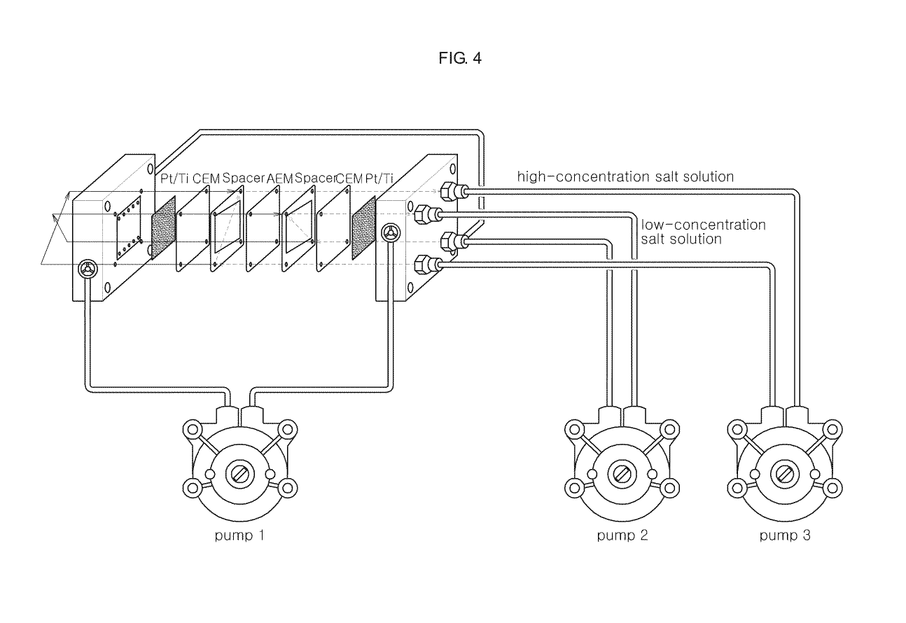

FIG. 4 is a schematic diagram showing a unit cell of the reverse electrodialysis equipment of the complex apparatus according to an embodiment of the present disclosure.

Referring to FIG. 4, an anion exchange membranes [Selemion™, AMV, about 5 cm×about 5 cm, about 120 μm] is interposed between cation exchange membranes [Selemion™, CMV, about 5 cm×about 5 cm, about 20 μm], and an anode and a cathode are respectively mounted to ends thereof.

Ti [about 3 cm×about 3 cm] in a mesh form deposited with Pt was employed as the electrode. Platinum wire (φ=about 1 mm) was employed as the current collector. A spacer [about 4.2 cm×about 5.3 cm, about 280 um, area=about 11.13 cm²] was provided between the cation exchange membrane and the anion exchange membrane. In addition, (though not shown in the figures) a Teflon gasket (about 320 um) was used at the electrode.

In an actual large-sized system, a stack may be used in which unit cells, each having a cathode, an ion exchange membrane and an anode, are stacked.

Pumps (2, 3) [for example, peristaltic pumps] were respectively connected to the unit cell (or the stack) to supply high-concentration concentrated sea water, sea water and/or low-concentration fresh water.

The fresh water or concentrated sea water passing reverse electrodialysis equipment may be discharged.

Pump 1 [for example, peristaltic pump] is used for circulating a rinsing solution provided to the electrodes. For reference, ion exchange occurs through membrane, which induces oxidation/reduction reaction of metal salts in the rinsing solution. During the process electrons moves through electrodes and generate currents.

When a desalination plant is coupled with a reverse electrodialysis equipment, a concentrated sea water is provided to the reverse electrodialysis equipment. For reproducing this, the high-concentration salt solution to be supplied to the reverse electrodialysis equipment was adjusted in Example and Comparative Example 1 to have a salt (NaCl) concentration of about 60 g/L.

Meanwhile, in order to reproduce the case where a desalination plant is not coupled with a reverse electrodialysis equipment, the high-concentration salt solution to be supplied to the reverse electrodialysis equipment was adjusted in Comparative Example 2 to have a salt (NaCl) concentration of about 30 g/L.

As for the low-concentration salt solution used in the reverse electrodialysis equipment, fresh water having a salt (NaCl) concentration of about 1 g/L was used in Example.

The respective concentrations of the high-concentration salt solutions and the low-concentration salt solutions of the Example and Comparative Examples are as follows.

TABLE 1

| | high-concentration | low-concentration |
|---|---|---|
| | salt solution | salt solution |
| Example 1 | 60 g/L | 1 g/L |
| [DSU-RED (concentrated | | |
| sea water/fresh water)] | | |
| Comparative Example 1 | 60 g/L | 30 g/L |
| [DSU-RED (concentrated | | |
| sea water/sea water)] | | |
| Comparative Example 2 | 30 g/L | 1 g/L |
| [RED (sea water/fresh | | |
| water)] | | |

Performance of the Example and Comparative Examples was measured in Experiment 1.

A device used for measuring the performance was HCP-803 (from Bio-Logic SAS) which is a current/voltage applying device. In this experiment, a potential was measured by controlling a current generated in the system at a rate of about 0.1 mA/s from 0 to about 30 mA.

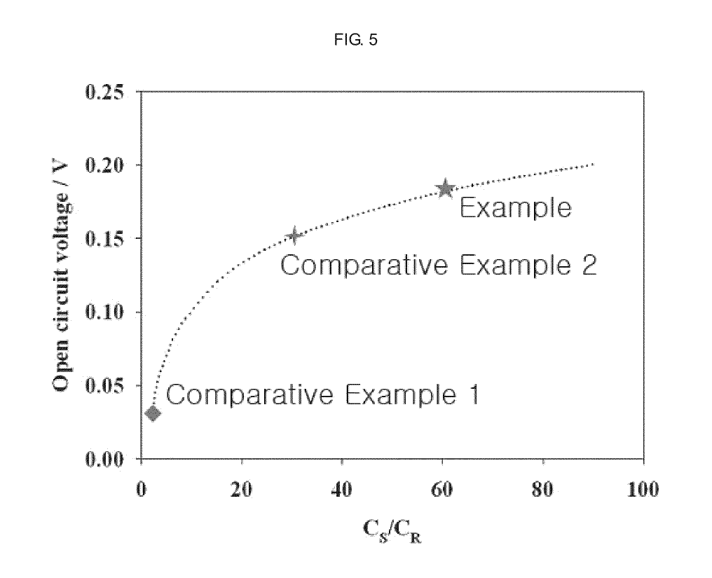

FIG. 5 is a graph for evaluating power performance of the Example 1 of the present disclosure, Comparative Example 1 and Comparative Example 2. In FIG. 5, an X axis represents a concentration ratio (Cs/Cr) and a Y axis represents an open circuit voltage (OCV).

Table 2 below shows OCVmax, Pmax and R (resistance) of the Example 1 and Comparative Examples 1 and 2. The Example 1 and Comparative Examples 1 and 2 denoted below are belonging to this Experiment 1.

TABLE 2

| | concen- | | | |
|---|---|---|---|---|
| | tration | OCV | Pmax | R |
| | difference | (V) | (mW/cm²) | (Ω) |
| Example 1 | 60 g/L:1 g/L | 0.181 | 0.098 | 7.40 |
| Comparative | 60 g/L:30 g/L | 0.022 | 0.00375 | 3.12 |
| Example 1 | | | | |
| Comparative | 30 g/L:1 g/L | 0.155 | 0.0588 | 9.16 |
| Example 2 | | | | |

As shown in FIG. 5 and Table 2, in the Example 1, the performance was improved about 26 times in terms of the power density as compared to Comparative Example 1 [DSU-RED (concentrated sea water/sea water)].

In addition, as compared to Comparative Example 2, OCV increases, the resistance decreases, and the power density is improved.

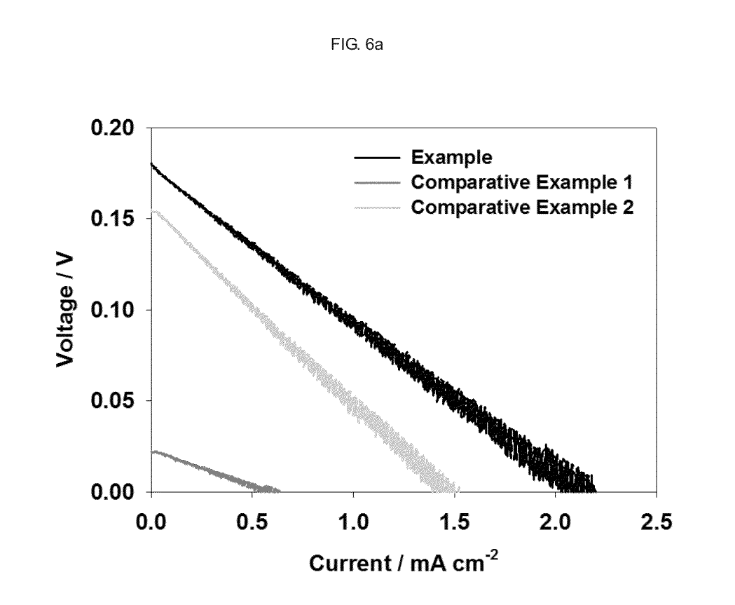

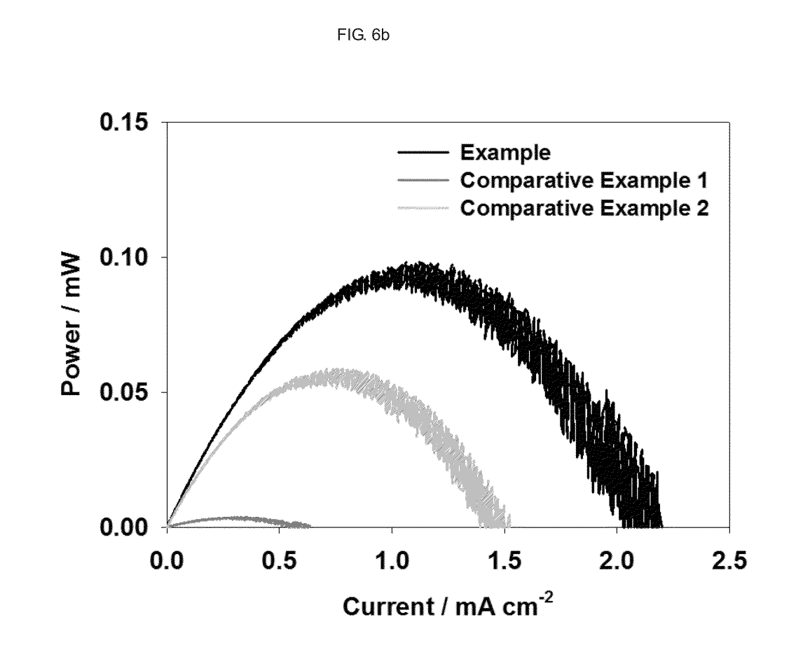

FIG. 6 shows an I-V curve (FIG. 6a) representing output currents and voltages of the Example 1 of the present disclosure, Comparative Example 1 and Comparative Example 2 and an I-P curve (FIG. 6b) representing output currents and powers of the Example 1 of the present disclosure, Comparative Example 1 and Comparative Example 2. In FIG. 6a, an X axis represents a current density (unit: mA/cm²) and a Y axis represents a voltage (unit: V). In FIG. 6b, an X axis represents a current density (unit: mA/cm²) and a Y axis represents a power density (unit: mW/cm²).

As shown in FIG. 6, it may be found that the output voltage and power of the Example 1 were very high and performance was greatly improved.

Meanwhile, Experiment 2 to 4, Tables 3 to 5, and FIGS. 7 to 9 show a calculated result of a theoretical value according to the above equations to check the increasing tendency of power density according to the change of concentration of a low-concentration salt solution. Herein, since the resistance (R) may vary according to characteristic, thickness or the like of the membrane in the equation, relative values (Rel. Pmax) of Pmax are just shown in the Experiment 2 to 4 below on the assumption that R is constant.

### Experiment 2

In Experiment 2, a salt concentration (Cs) of concentrated sea water was set to about 50 g/L, and then a concentration ratio (Cs/Cr), OCV, and relative Pmax (Rel. Pmax) were observed while changing a salt concentration (Cr) of low salinity water. The relative Pmax (Rel. Pmax) means a ratio of Pmax of each Example with respect to Pmax of Comparative Example 3. That is, Rel. Pmax of Comparative Example 3 is 1. Rel. Pmax of each Example is Pmax of each Example/Pmax of Comparative Example 3.

Table 3 shows OCV and Rel. Pmax according to the change of Cs/Cr when the concentrated sea water has a salt concentration (Cs) of about 50 g/L. For reference, the Examples and Comparative Example below belong to Experiment 2.

TABLE 3

| | salt | | | | |
|---|---|---|---|---|---|
| | concen- | | | | |
| | tration | | | | |
| | Cs | Cr | | OCV | Rel. |
| | (g/L) | (g/L) | Cs/Cr | (V) | Pmax |
| Comparative | 50 | 30 | 1.7 | 0.022331706 | 1.00 |
| Example 3 | | | | | |
| Example 2 | 50 | 20 | 2.5 | 0.040103935 | 3.225003287 |
| Example 3 | 50 | 19 | 2.6 | 0.042357794 | 3.597682771 |
| Example 4 | 50 | 18 | 2.8 | 0.044735218 | 4.01287198 |
| Example 5 | 50 | 17 | 2.9 | 0.047250543 | 4.476821725 |
| Example 6 | 50 | 16 | 3.1 | 0.049920747 | 4.997103456 |
| Example 7 | 50 | 15 | 3.3 | 0.052766134 | 5.582988553 |
| Example 8 | 50 | 14 | 3.6 | 0.055811262 | 6.245969817 |
| Example 9 | 50 | 13 | 3.8 | 0.059086221 | 7.000492921 |
| Example 10 | 50 | 12 | 4.2 | 0.062628416 | 7.865005857 |
| Example 11 | 50 | 11 | 4.5 | 0.066485147 | 8.863504332 |
| Example 12 | 50 | 10 | 5.0 | 0.07071742 | 10.02787724 |
| Example 13 | 50 | 9 | 5.6 | 0.075405792 | 11.40159492 |
| Example 14 | 50 | 8 | 6.3 | 0.080659698 | 13.04575966 |
| Example 15 | 50 | 7 | 7.1 | 0.086633075 | 15.04955485 |
| Example 16 | 50 | 6 | 8.3 | 0.093552209 | 17.54948134 |
| Example 17 | 50 | 5 | 10.0 | 0.101769362 | 20.76779055 |
| Example 18 | 50 | 4 | 12.5 | 0.111877441 | 25.09812294 |
| Example 19 | 50 | 3 | 16.7 | 0.124994008 | 31.3281377 |
| Example 20 | 50 | 2 | 25.0 | 0.143644623 | 41.3747074 |
| Example 21 | 50 | 1 | 50.0 | 0.175959005 | 62.0839281 |
| Example 22 | 50 | 0.5 | 100.0 | 0.208768599 | 87.39499131 |
| Example 23 | 50 | 0.2 | 250.0 | 0.252769251 | 128.1163839 |
| Example 24 | 50 | 0.1 | 500.0 | 0.28642575 | 164.5054571 |
| Example 25 | 50 | 0.05 | 1000.0 | 0.320321379 | 205.7444089 |
| Example 26 | 50 | 0.02 | 2500.0 | 0.365396286 | 267.7222388 |

FIG. 7a is a graph showing an OCV according to the concentration of low salinity water in Experiment 2 of the present disclosure. In FIG. 7a, an X axis represents a concentration of low salinity water (unit: g/L) and a Y axis represents an OCV (unit: V).

FIG. 7b is a graph showing a relative power density (Rel. Pmax) according to a concentration of low salinity water in Experiment 2 of the present disclosure. In FIG. 7b, an X axis represents a concentration of low salinity water (unit: g/L) and a Y axis represents a relative power density (Rel. Pmax) (unit: none).

As shown in Table 3 and FIG. 7, when the concentrated sea water had a salt concentration of about 50 g/L and the low salinity water had a salt concentration of about 20 g/L, the output (Rel. Pmax) was improved about three times or more, and when the low salinity water had a salt concentration of about 10 g/L or below, the output was improved about ten times or more. The output was significantly improved at a salt concentration of particularly preferably about 2 g/L or less, most preferably about 1 g/L or less.

### Experiment 3

In Experiment 3, the salt concentration (Cs) of concentrated sea water was set to about 60 g/L, a concentration ratio (Cs/Cr), OCV, and relative Pmax (rel. Pmax) were observed while changing a salt concentration (Cr) of low salinity water.

The relative Pmax (Rel. Pmax) is a ratio of Pmax of each Example with respect to Pmax of Comparative Example 4. In other words, Rel. Pmax of Comparative Example 4 is 1. Rel. Pmax of each Example is Pmax of each Example/Pmax of Comparative Example 4.

Table 4 shows OCV and Rel. Pmax according to the change of Cs/Cr when the concentrated sea water has a salt concentration (Cs) of about 60 g/L.

For reference, the Examples and Comparative Example below belong to Experiment 3.

TABLE 4

| | salt | | | | |
|---|---|---|---|---|---|
| | concen- | | | | |
| | tration | | | | |
| | Cs | Cr | | OCV | Rel. |
| | (g/L) | (g/L) | Cs/Cr | (V) | Pmax |
| Comparative | 60 | 30 | 2.0 | 0.03030335 | 1.00 |
| Example 4 | | | | | |
| Example 27 | 60 | 20 | 3.0 | 0.048075579 | 2.516910413 |
| Example 28 | 60 | 19 | 3.2 | 0.050329438 | 2.758435816 |
| Example 29 | 60 | 18 | 3.3 | 0.052706862 | 3.025192634 |
| Example 30 | 60 | 17 | 3.5 | 0.055222187 | 3.320824477 |
| Example 31 | 60 | 16 | 3.8 | 0.057892391 | 3.649737989 |
| Example 32 | 60 | 15 | 4.0 | 0.060737777 | 4.017320774 |
| Example 33 | 60 | 14 | 4.3 | 0.063782906 | 4.430240716 |
| Example 34 | 60 | 13 | 4.6 | 0.067057865 | 4.896865335 |
| Example 35 | 60 | 12 | 5.0 | 0.07060006 | 5.427862783 |
| Example 36 | 60 | 11 | 5.5 | 0.074456791 | 6.037085812 |
| Example 37 | 60 | 10 | 6.0 | 0.078689064 | 6.742911773 |
| Example 38 | 60 | 9 | 6.7 | 0.083377436 | 7.570347099 |
| Example 39 | 60 | 8 | 7.5 | 0.088631342 | 8.554475098 |
| Example 40 | 60 | 7 | 8.6 | 0.094604719 | 9.746402006 |
| Example 41 | 60 | 6 | 10.0 | 0.101523853 | 11.22418721 |
| Example 42 | 60 | 5 | 12.0 | 0.109741006 | 13.11464659 |
| Example 43 | 60 | 4 | 15.0 | 0.119849085 | 15.64185176 |
| Example 44 | 60 | 3 | 20.0 | 0.132965652 | 19.25296638 |
| Example 45 | 60 | 2 | 30.0 | 0.151616266 | 25.03285097 |
| Example 46 | 60 | 1 | 60.0 | 0.183930649 | 36.84061961 |
| Example 47 | 60 | 0.5 | 120.0 | 0.216740243 | 51.1561473 |
| Example 48 | 60 | 0.2 | 300.0 | 0.260740894 | 74.03498974 |
| Example 49 | 60 | 0.1 | 600.0 | 0.294397394 | 94.38144924 |
| Example 50 | 60 | 0.05 | 1200.0 | 0.328293023 | 117.3659247 |
| Example 51 | 60 | 0.02 | 3000.0 | 0.37336793 | 151.8073302 |

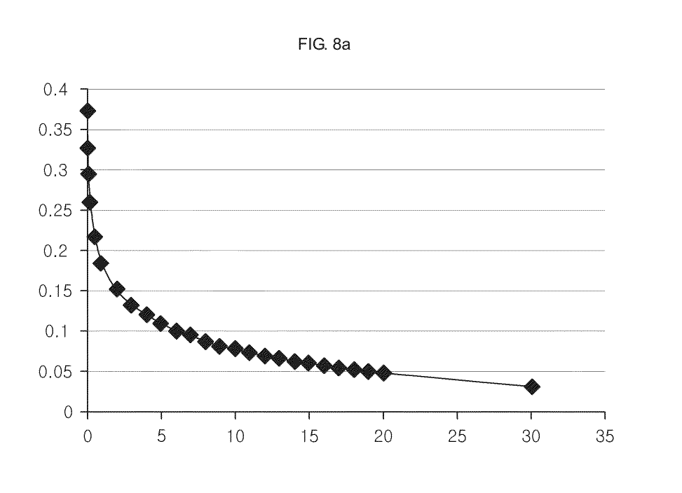

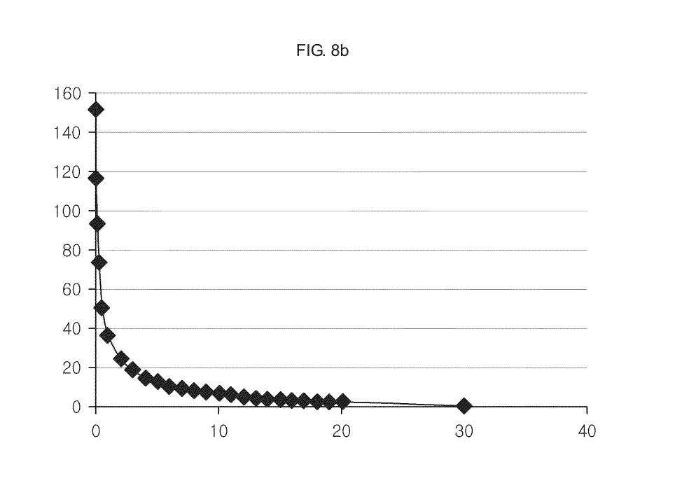

FIG. 8a is a graph showing an OCV according to a concentration of low salinity water in Experiment 3 of the present disclosure. In FIG. 8a, an X axis represents a concentration of low salinity water (unit: g/L) and a Y axis represents an OCV (unit: V).

FIG. 8b is a graph showing a relative power density (Rel. Pmax) according to a concentration of low salinity water in Experiment 3 of the present disclosure. In FIG. 8b, an X axis represents a concentration of low salinity water (unit: g/L) and a Y axis represents a relative power density (Rel. Pmax) (unit: none).

As shown in Table 4 and FIG. 8, in case that the concentrated sea water had a salt concentration of about 60 g/L, the output (Rel. Pmax) was improved about 2.5 times or more when the low salinity water had a salt concentration of about 20 g/L, and when the low salinity water had a salt concentration of about 6 g/L or less, the output was improved about ten times or more. The output was significantly improved at a salt concentration of particularly preferably about 2 g/L or less, most preferably about 1 g/L or less.

### Experiment 4

In Experiment 4, the salt concentration (Cs) of concentrated sea water was set to about 75 g/L, and then a concentration ratio (Cs/Cr), OCV, and relative Pmax (rel. Pmax) were observed while changing a salt concentration (Cr) of low salinity water.

The relative Pmax (Rel. Pmax) means a ratio of Pmax of each Example with respect to Pmax of Comparative Example 5. In other words, Rel. Pmax of Comparative Example 5 is 1. Rel. Pmax of each Example is Pmax of each Example/Pmax of Comparative Example 5.

Table 5 shows OCV and Rel. Pmax according to the change of Cs/Cr when the concentrated sea water has a salt concentration (Cs) of about 75 g/L.

For reference, the Examples and Comparative Example below belong to Experiment 4.

TABLE 5

| | salt | | | | |
|---|---|---|---|---|---|
| | concen- | | | | |
| | tration | | | | |
| | Cs | Cr | | OCV | Rel. |
| | (g/L) | (g/L) | Cs/Cr | (V) | Pmax |
| Comparative | 75 | 30 | 2.5 | 0.04007083 | 1.00 |
| Example 5 | | | | | |
| Example 52 | 75 | 20 | 3.8 | 0.057843058 | 2.083751022 |
| Example 53 | 75 | 19 | 3.9 | 0.060096918 | 2.2493018 |
| Example 54 | 75 | 18 | 4.2 | 0.062474341 | 2.430785881 |
| Example 55 | 75 | 17 | 4.4 | 0.064989666 | 2.630461503 |
| Example 56 | 75 | 16 | 4.7 | 0.06765987 | 2.851055398 |
| Example 57 | 75 | 15 | 5.0 | 0.070505257 | 3.095895795 |
| Example 58 | 75 | 14 | 5.4 | 0.073550386 | 3.369094886 |
| Example 59 | 75 | 13 | 5.8 | 0.076825344 | 3.675804167 |
| Example 60 | 75 | 12 | 6.3 | 0.08036754 | 4.022579911 |
| Example 61 | 75 | 11 | 6.8 | 0.084224271 | 4.417920043 |
| Example 62 | 75 | 10 | 7.5 | 0.088456544 | 4.873076894 |
| Example 63 | 75 | 9 | 8.3 | 0.093144916 | 5.40333187 |
| Example 64 | 75 | 8 | 9.4 | 0.098398821 | 6.030080725 |
| Example 65 | 75 | 7 | 10.7 | 0.104372199 | 6.784424269 |
| Example 66 | 75 | 6 | 12.5 | 0.111291333 | 7.713758156 |
| Example 67 | 75 | 5 | 15.0 | 0.119508485 | 8.894894855 |
| Example 68 | 75 | 4 | 18.8 | 0.129616565 | 10.4631957 |
| Example 69 | 75 | 3 | 25.0 | 0.142733131 | 12.68799273 |
| Example 70 | 75 | 2 | 37.5 | 0.161383746 | 16.22045069 |
| Example 71 | 75 | 1 | 75.0 | 0.193698129 | 23.36652787 |
| Example 72 | 75 | 0.5 | 150.0 | 0.226507722 | 31.95283223 |
| Example 73 | 75 | 0.2 | 375.0 | 0.270508374 | 45.57270016 |
| Example 74 | 75 | 0.1 | 750.0 | 0.304164874 | 57.61843394 |
| Example 75 | 75 | 0.05 | 1500.0 | 0.338060503 | 71.17577407 |
| Example 76 | 75 | 0.02 | 3750.0 | 0.383135409 | 91.4214102 |

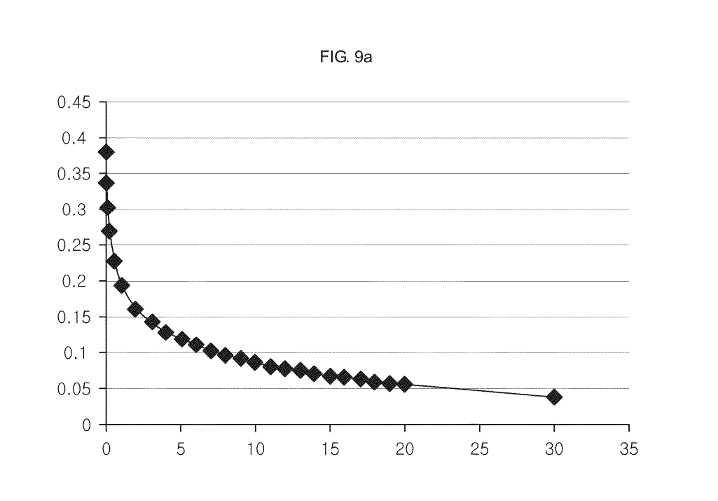

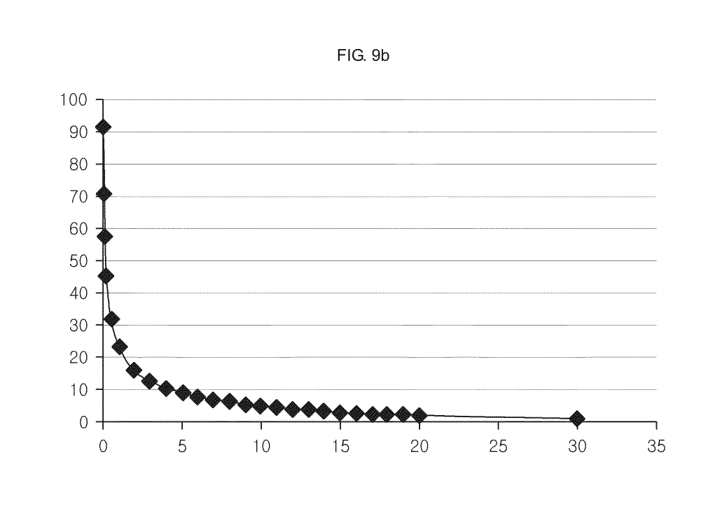

FIG. 9a is a graph showing an OCV according to a concentration of low salinity water in Experiment 4 of the present disclosure. In FIG. 9a, an X axis represents a concentration of low salinity water (unit: g/L) and a Y axis represents an OCV (unit: V).

FIG. 9b is a graph showing a relative power density (Rel. Pmax) according to a concentration of low salinity water in Experiment 4 of the present disclosure. In FIG. 9b, an X axis represents a concentration of low salinity water (unit: g/L) and a Y axis represents a relative power density (Rel. Pmax) (unit: none).

As shown in Table 5 and FIG. 9, in case that the concentrated sea water had a salt concentration of about 75 g/L, the output (Rel. Pmax) was improved about 2.0 times or more when the low salinity water had a salt concentration of about 20 g/L, and when the low salinity water had a salt concentration of about 4 g/L or less, the output was improved about ten times or more. The output was significantly improved at a salt concentration of particularly preferably about 2 g/L or less, most preferably about 1 g/L or less.

As described above, it may be understood that in case that the concentrated sea water has a salt concentration of about 50 to 75 g/L, the output may be improved by setting the low salinity water to have a salt concentration of about 20 g/L or less, and the output is significantly improved at a salt concentration of particularly preferably at about 2 g/L or less, most preferably at about 1 g/L or less. In addition, when the concentrated sea water had a salt concentration of particularly about 50 to 60 g/L and the low salinity water had a concentration of about 2 g/L or less, most preferably 1 g/L or less, Rel. Pmax was very significantly improved.

### Experiment 5

Meanwhile, in Experiments 2 to 4, the resistance (R) was assumed as being constant. Even though the change of resistance is taken into consideration, the changing tendency of power density (a significantly increasing tendency at a concentration of about 2 g/L or less, or particularly 1 g/L or less) is identically observed. To prove this, Experiment 5 shows a calculation result of Rel. Pmax obtained by considering the change of resistance in Experiment 3. Table 6 below shows the salt concentration of concentrated sea water, the salt concentration of low salinity water, the concentration ratio, and OCV as same as those of Table 4 of Experiment 3. However, Rel. Pmax according to the change of resistance was calculated.

TABLE 6

| | salt | | | | |
|---|---|---|---|---|---|
| | concen- | | | | |
| | tration | | | | |
| | Cs | Cr | | | |
| | (g/L) | (g/L) | Cs/Cr | R | Pmax |
| Comparative | 60 | 30 | 2.0 | 3.12 | 1.00 |
| Example 6 | | | | | |
| Example 77 | 60 | 20 | 3.0 | 4.5956 | 1.708756 |
| Example 78 | 60 | 19 | 3.2 | 4.7432 | 1.814454 |
| Example 79 | 60 | 18 | 3.3 | 4.8908 | 1.929869 |
| Example 80 | 60 | 17 | 3.5 | 5.0384 | 2.056401 |
| Example 81 | 60 | 16 | 3.8 | 5.186 | 2.195754 |
| Example 82 | 60 | 15 | 4.0 | 5.3336 | 2.350015 |
| Example 83 | 60 | 14 | 4.3 | 5.4812 | 2.521775 |
| Example 84 | 60 | 13 | 4.6 | 5.6288 | 2.714294 |
| Example 85 | 60 | 12 | 5.0 | 5.7764 | 2.931745 |
| Example 86 | 60 | 11 | 5.5 | 5.924 | 3.179559 |
| Example 87 | 60 | 10 | 6.0 | 6.076 | 3.464966 |
| Example 88 | 60 | 9 | 6.7 | 6.2192 | 3.797833 |
| Example 89 | 60 | 8 | 7.5 | 6.3668 | 4.192053 |
| Example 90 | 60 | 7 | 8.6 | 6.5144 | 4.667932 |
| Example 91 | 60 | 6 | 10.0 | 6.662 | 5.256599 |
| Example 92 | 60 | 5 | 12.0 | 6.8096 | 6.008825 |
| Example 93 | 60 | 4 | 15.0 | 6.9572 | 7.014687 |
| Example 94 | 60 | 3 | 20.0 | 7.1048 | 8.454743 |
| Example 95 | 60 | 2 | 30.0 | 7.2524 | 10.76919 |
| Example 96 | 60 | 1 | 60.0 | 7.4 | 15.5328 |
| Example 97 | 60 | 0.5 | 120.0 | 7.4738 | 21.35556 |
| Example 98 | 60 | 0.2 | 300.0 | 7.5108 | 30.72449 |
| Example 99 | 60 | 0.1 | 600.0 | 7.53284 | 39.09151 |
| Example 100 | 60 | 0.05 | 1200.0 | 7.75022 | 48.56379 |
| Example 101 | 60 | 0.02 | 3000.0 | 7.544648 | 62.77813 |

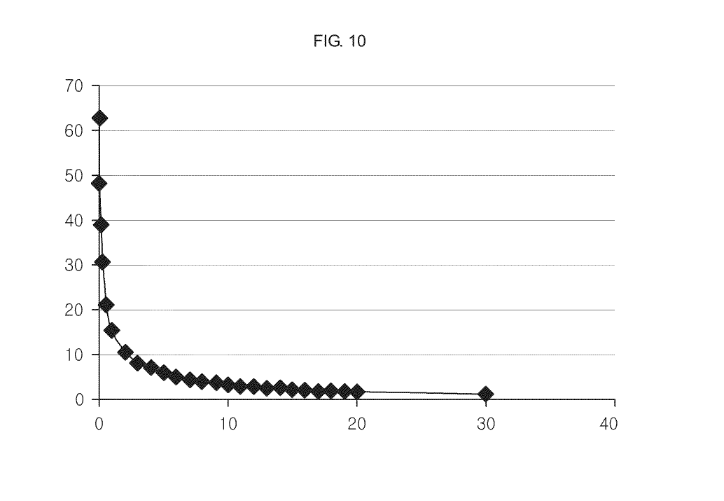

FIG. 10 is a graph showing a relative power density (Rel. Pmax) according to a concentration of low salinity water in Experiment 5 of the present disclosure (namely, a graph showing Rel. Pmax according to a concentration of low salinity water, wherein Rel. Pmax is calculated according to a resistance change in Experiment 3). In FIG. 10, an X axis represents a concentration of low salinity water (unit: g/L) and a Y axis represents a relative power density (Rel. Pmax) (unit: none).

As shown in Table 6 and FIG. 10, even though the change of resistance is taken into consideration, the output was significantly improved at a salt concentration of particularly about 2 g/L or less, most preferably about 1 g/L or less.

As described above, it may be understood that in case that the concentrated sea water has a salt concentration of about 50 to 75 g/L (or, preferably about 50 to 60 g/L), the output was significantly improved at a salt concentration of particularly preferably about 2 g/L or less, most preferably about 1 g/L or less.

While the exemplary embodiments have been shown and described, it will be understood by those skilled in the art that various changes in form and details may be made thereto without departing from the spirit and scope of the present disclosure as defined by the appended claims. In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

What is claimed is:

1. A method for improving a power density of a reverse electrodialysis equipment in a complex apparatus of a desalination plant and the reverse electrodialysis equipment, comprising:
supplying a sea water to the desalination plant and at least partially desalinize the sea water into a fresh water,
supplying a concentrated sea water, whose salt concentration is increased to about 50 to 75 g/L after the desalinization, to the reverse electrodialysis equipment,
supplying a low salinity water having a salt concentration of about 0.01 to 20 g/L to the reverse electrodialysis equipment.

2. The method according to claim 1, wherein the low salinity water has a salt concentration of about 0.01 to 2 g/L.

3. The method according to claim 1, wherein the low salinity water has a salt concentration of about 0.01 to 1 g/L.

4. The method according to claim 1, wherein the concentrated see water of about 50 to 60 g/L is supplied to the reverse electrodialysis equipment, and
the low salinity water of has a salt concentration of about 0.01 to 2 g/L.

5. The method according to claim 1, wherein the concentrated see water of about 50 to 60 g/L is supplied to the reverse electrodialysis equipment, and
the low salinity water of has a salt concentration of about 0.01 to 1 g/L.

6. The method according to claim 2, wherein the concentrated sea water which passes through and is discharged from the reverse electrodialysis equipment is resupplied to the reverse electrodialysis equipment.

7. The method according to claim 6, wherein a concentration reduction degree of the concentrated sea water after passing the reverse electrodialysis equipment is 1/1000 or less.

8. The method according to claim 2, wherein a fresh water which is river water, stored rainwater, discharge water after sewage disposal, discharge water from power plants, or discharge water from steelworks is used as the low salinity water, and the fresh water has the salt concentration of the low salinity water.

9. A complex apparatus comprising:
a desalination plant, wherein the desalination plant receives a sea water, desalinize at least a part of the sea water into a fresh water, and discharges a concentrated sea water whose concentration is increased after the desalinization,
a reverse electrodialysis equipment, wherein the concentrated sea water discharged from the desalination plant is provided to the reverse electrodialysis equipment as a high-concentration salt solution,
a low salinity water supplying unit for providing a low salinity water to the reverse electrodialysis equipment as a low-concentration salt solution,
wherein the concentrated sea water has a salt concentration of about 50 to 75 g/L, and the low salinity water has a salt concentration of about 0.01 to 20 g/L.

10. The complex apparatus according to claim 9, wherein the low salinity water has a salt concentration of about 0.01 to 2 g/L.

11. The complex apparatus according to claim 9, wherein the low salinity water has a salt concentration of about 0.01 to 1 g/L.

12. The complex apparatus according to claim 9, wherein the concentrated see water has a salt concentration of about 50 to 60 g/L, and
the low salinity water has a salt concentration of about 0.01 to 2 g/L.

13. The complex apparatus according to claim 9, wherein the concentrated see water has a salt concentration of about 50 to 60 g/L, and
the low salinity water has a salt concentration of about 0.01 to 1 g/L.

14. The complex apparatus according to claim 10, further comprising:
a discharged concentrated sea water resupplying unit for resupplying the concentrated sea water, which passes through and is discharged from the reverse electrodialysis equipment, to the reverse electrodialysis equipment.

15. The complex apparatus according to claim 14, wherein a concentration reduction degree of the concentrated sea water after passing the reverse electrodialysis equipment is 1/1000 or less.

16. The complex apparatus according to claim 10, further comprising:
a fresh water providing unit for providing a fresh water selected from the group consisting of river water, stored rainwater, discharge water after sewage disposal, discharge water from power plants and discharge water from steelworks to the reverse electrodialysis equipment; and
a concentration measuring and adjusting unit for measuring and adjusting a concentration of the fresh water.

17. The complex apparatus according to claim 10, wherein power produced by the reverse electrodialysis equipment is provided to the desalination plant.
